(19) United States
(12) Patent Application Publication
(10) Pub. No.: US 2019/0347888 A1
(43) Pub. Date: Nov. 14, 2019

(54) DOCUMENT AUTHENTICATION SYSTEM

(71) Applicant: BOTOSOFT TECHNOLOGIES LTD, London (GB)

(72) Inventor: Babatope AGBEYO, London (GB)

(21) Appl. No.: 16/467,459

(22) PCT Filed: Jul. 13, 2017
(86) PCT No.: PCT/GB2017/000107

§ 371 Date: Jun. 6, 2019

(30) Foreign Application Priority Data
Jul. 13, 2016 (GB) 1612162.6
May 19, 2017 (GB) 1708090.4

(51) Int. Cl. G07D 7/0043; G06K 7/10

(52) U.S. Cl. CPC G07D 7/0043; B42D 25/29; G07D 2207/00; G06K 7/10297

(57) ABSTRACT

A secure document verification system is described, for verifying the authenticity of secure documents' The secure documents each comprise a paper document having a radio frequency tag, e.g. a NFC tag, and a document identification code. The system comprises a database storing data representing a plurality of signed secure documents, wherein each document is signed using a pairing of tag and document identification codes, received in a signing or calibration stage. The system is arranged responsive to receiving a verification request from a remote device, which request contains the tag identification data, to compare the tag identification data with the signed documents, and responsive to a match, to transmit back to the remote device a verification message.

### FIELD OF THE INVENTION

This invention relates to a method and system for document authentication, particularly paper or paper-like documents.

More especially the invention relates to a system for verifying the authenticity of a paper document using Near Field Communication (“NFC”). The invention further relates to a system for verifying the authenticity of a paper document comprising of an NFC tag, a mobile reader and compatible applications built for such purpose, for the validation of the authenticity of a documents and items making use of the Near Field technology between the NFC tag and the mobile reader.

### BACKGROUND OF THE INVENTION

Document forgery and/or counterfeiting is a well-known problem. For example, paper documents such as bank notes, bank cheques, educational certificates, diplomas, stock certificates, and so on, represent documents that are commonly forged.

There is therefore a need for a method and system by which a party can authenticate a presented document so that they can be confident that it is genuine.

The present invention is an NFC based solution of verifying paper documents and/or the authenticity of a product. NFC technology is enjoying a high and fast rate of acceptability in the world and with the advent of NFC compatible smartphones, the application of the technology has become limitless. The system involves the use of NFC technology for the validation of documents and/or products (for example, without limitation, food, drinks or electronics products). This is achieved by the use of a holographic NFC chip, and a bespoke signature application and verification application which run on an NFC enabled mobile device. The frequency of an NFC radio signal is 13.5 MHz, therefore the application of the NFC technology in this solution is perfectly practical.

To importance of authenticating valid items cannot be over-emphasized in the fight against counterfeiting. Lots of methods have and are being used, with varying levels of success in bid to prevent forgery, tampering, or counterfeiting of items entering the market.

There are many forms of authentication depending on whether the authentication relates to a document or a product.

For issued documents, known forms of identification include, without limitation, security prints, signatures/stamps, online portals or QR codes.

Security prints tend to use special paper, watermarks, intaglio printing, geometric lathe work, micro printing, holograms, security threads and/or magnetic ink to make it easier for a verifying party to determine authenticity. However, these technologies rely on the experience of the verifying party, and advancements in counter-technology have placed the ability to forge documents or items within the reach of individuals who have sufficient funds and equipment. Such advancements have made it possible to produce forged or counterfeit paper documents within the reach of individuals who only need to be able to afford an up-to-date PC, a good quality colour laser printer and a high resolution scanner. With the technical know-how, and access to special paper and security inks, most individuals could produce a fake document.

Signatures and stamps of the issuers are usually the main evidence or determinant of the authenticity of documents such as certificates, letters, memos, passports and many more types of documents. This method is not an efficient way of determining the authenticity of a document as signatures can easily be forged and duplicated, while stamps and seals can be stolen or cloned and used by the intending individual. This method of determining authenticity is the major cause of the problem of document forgery and needs to be addressed on a global level.

Online portals, which are created by document issuers, have also been used for document verifications. Documents such as certificates could be verified by using an online portal where the information on the certificate is matched against a database stored on a server. This method is limited in its ability to counter document falsification because of the limited access to the online document verification portal. Also the information on the portal is often insecure as, as such, is prone to being hacked, which would affect the integrity of the information on the portal.

Quick Response (QR) codes are graphical codes similar to barcodes which are sometimes fixed to certificates, e.g. educational certificates, for reading by a scanner or reader. Quick Response codes are printed on the documents and are read using scanners to determine the authenticity of a document. The QR code is not totally efficient for this problem as it is less secure. Corporate bodies and Educational institutions make use of this method but it is highly insecure as a QR code can easily be cloned and reprinted on another identical document with the same information on it, hence, the authenticity of such document cannot be validated by the use of QR codes.

In terms of products, authentication methods include, again without limitation, unique packaging or design, QR codes, USSD and scratch panels and (if appropriate) unique tastes or smells.

In terms of unique packaging and design, brand owners spend considerable amount of time, energy and money to create innovative design in packaging their product in a verge to make counterfeiting almost impossible. Wine bottles, for example, are bottled in varying uniquely designed styles.

QR Codes are now used to validate the genuineness of a product in a bid to address counterfeiting by brand owners, customers are expected to scan the QR code printed on such items. A valid response is displayed to the customer upon scanning to confirm whether the product is genuine or not. While QR code standards allow any smartphone user to capture the code, it also allows almost any counterfeiting operation to mimic the information associated with an authentic product by presenting falsified information within a website or application that appears to be authentic. For instance, a fake product may have a QR code that directs users to a website that looks legitimate but is actually controlled by a counterfeiting operation.

Recently, brand owners adopt the use of USSD and scratch panel secret codes to protect their brands, this technology allows consumers to validate the genuineness of a product by scratching the panel where the secret code is hidden. The customer is expected to send this secret code to a specified short code so as to confirm the originality of the product/item. This technology often fails due to the fact that counterfeiters create similar short codes and valid secret keys, upon checking for the originality of the item, a valid response may be displayed to the customer as though it was genuinely manufactured by the brand owner. A counterfeit box, for example, often have a counterfeit short code that always returns a positive product authentication.

Brand owners are continually investing in new technologies in an attempt to eliminate the impact of counterfeiting. For instance, champagne is by definition related to a region, specific grape varieties and method of production which contributes to the originality of the wine. Unfortunately counterfeiters are able create copy products that taste and smell almost the same as the original. While end users fall victim to the purchase of fake products, few end up reporting such experience to the vendor since by then the product has been purchased and taken out of the store.

In recent years, a lot of effort have been made by counterfeiters to make money from fake goods, issued documents, etc. This menace has seen brand owners across the world lose trillions of dollars and it its prevalence is increasing every day. Brand owners are forced to put varying security measure to protect their brands.

The forging of documents, such as education certificates is a major problem in countries like Nigeria, as individuals are able to easily obtain false documents to obtain employment. In April 2014 for example, 26 members of parliament lost their jobs due to the fact that they presented false documents and certificates during the employment interview. This is a big problem in Nigeria and the world as a whole.

A method and system developed for anti-counterfeit and identity theft prevention with genuine item identification and verification therefore would enormously help in effectively solving, preventing and immensely minimizing the occurrence of counterfeit-related frauds.

Currently, the aforementioned existing systems of document and product authentication are faced with major problems as they are not effective enough to curb the problem of document falsification and counterfeit products.

It is an aim therefore to provide an improved method and system for authentication of documents and/or products.

### SUMMARY OF THE INVENTION

A first aspect of the invention provides a method comprising:

(a) receiving from a contactless radio frequency tag provided on a document tag identification data stored on the said tag; (b) receiving document identification data provided on and associated with the document; and (c) transmitting data representing the tag identification data and the document identification data as a linked pair to a remote device.

The document identification data may be fixed on the document, at a spatially separate location from the radio frequency tag.

The document identification data may be provided in the form of a visible text or graphic marking.

The document identification data may be provided in a barcode or a quick response (QR) code.

The document identification data may be received from image data which represents a captured part of the document. The image data may be received from an image capture application opened responsive to receiving the tag identification data.

The method may be performed using a mobile communications device having contactless RFID or NFC reading capability.

A second aspect provides a method of authenticating a document, comprising: (A) storing for at least one document a set of linked validation data comprising (i) tag identification data associated with a radio frequency tag on the document, and (ii) document identification data provided on and associated with the document; (B) receiving a verification request from a remote communications device, which verification request includes tag identification data; (C) comparing the received tag identification data in the verification request with the or each set of stored validation data; and (D) responsive to identifying a correspondence between the received and stored tag identification data in step (C) transmitting an authentication message back to the remote communications device.

In step (B) the verification request may further identify a user and/or device, and in which subsequent steps are performed only if the user and/or device is pre-registered.

In step (B) the verification request may comprise an encoded form of the tag identification data.

In step (B) the verification request may be received as a URL or received in text format.

Step (D) may include providing to the remote communications device the document identification data, or other data associated therewith, which corresponds to the verified tag identification data.

According to a further aspect, there is provided a method comprising an NFC-compatible device, wherein the device is configured to receive via an NFC reader, encoded data associated with a physical paper document or product or any item that may be counterfeited wherein the encoded data is a string of URL which contains the Tag Authentication Cryptogram, the One-Time-Passcode, the TagID and other credentials.

The device which could be a smartphone should be able to capture one and/or more input through its input devices (i.e. RFID/NFC reader and a camera). The device transmits such data through the web to an online authenticator.

The system may be composed of the following components:
a paper document or a sampled product/item tagged with an NFC Tag which generates unique information each time it is scanned;
a signature or signing application which calibrates the item for future verification. The application performs the function of digital signing of an item;
a verification or verifier application which serves to carry out the verification process for the item; and
a web server which serves as a repository for the unique document designations for all signed paper documents and which can be queried by the verification application during a verification process to return a valid or invalid message to the user of the application depending on the response of the document validation.

The system may further comprise:
a document/product signing mobile application, wherein the application runs on a device to be made available to the issuer upon registration. This application can also run on a desktop to automate batch signing of documents;
a document/product verifying application that runs on an NFC-compatible smartphone;
an NFC sticker tag, wherein the holographic layer is designed with respect to the issuer's specification;
a paper, wherein the paper may be securely printed to have one or more of the following print technologies: special paper, watermark, intaglio printing, geometric lathe work, micro printing, hologram, security threads, or magnetic ink; or an item, wherein the item may be a branded product, a packaged food or drink, an electronic device or gadget and any other items that may be counterfeited.
an authenticator.

The paper document may include but not limited to bank cheques, stocks, currency, certificates, shares documents, bonds.

The paper document may contain other authentication data which could be printed on the surface of the document in form of barcode, QR Code, or other secure print technology.

The NFC-compatible device could be smartphone or a mobile handheld terminal.

The holographic NFC tag sticker may be a secure tag capable of generating a tag authentication cryptogram when tapped by an NFC-compatible smartphone.

The paper may be tagged with the holographic NFC sticker which will be digitally signed with the signing application by tapping the device on the tag and scanning the QR/barcode (a code which uniquely identifies each document) so as to uniquely represent the document on the web application server.

This activity is carried out prior to when the document is issued to the document owner.

The smartphone, upon fetching the parameters on the tag, may browse to the URL, invoking an issuer-specific web application which calls together the TAC/OTP, Tag ID and other credentials into a servlet POST request.

The verification application may be designed to verify the authenticity of the paper document/product/items by tapping the device on the holographic NFC tag sticker.

The device through electromagnetic induction may fetch the OTP URL alongside with other validator's credentials to an authenticator (i.e. a web application).

The authenticator may be designed specific to individual issuer and contains credentials to authenticate the secure tag through the mobile application. A service that may depends on the requirement of the issuer.

The authenticator may warehouse the issuer's data, a part or all of the paper document data, and the validator's or interrogator's data.

The document signing application may display “Document Signed Successfully” on the device to guarantee the issuer that the document signing was successful.

The verification application may display to the issuer specific message that confirms/rejects the authenticity of the issued document/product.

The digital copy of the issued document may be sent from the application to an authorized recipient.

### BRIEF DESCRIPTION OF THE DRAWINGS

The invention will now be described by way of non-limiting example, with reference to the drawings, in which:

FIG. 1 shows a document which carries a Near Field Communications (NFC) tag and a separate printed identifier, in accordance with preferred embodiments;

FIG. 2 is a close-up view of the reverse side of the NFC tag shown in FIG. 1;

FIG. 3 is a schematic view of the FIG. 2 NFC tag;

FIG. 4 is a functional diagram of the FIG. 2 NFC tag;

FIG. 5 is a schematic block diagram showing components of a reader smartphone according to preferred embodiments;

FIG. 6 is a schematic block diagram showing the document and smartphone in relation to an authentication server according to preferred embodiments;

FIG. 7 is a flow diagram indicating processing steps performed by one or more software applications in a signing or calibration stage, according preferred embodiments;

FIGS. 8a-8d show screen shots of a graphical user interface (GUI) presented by the smartphone in different stages of the signing or calibration stage;

FIG. 9 is a flow diagram indicating processing steps performed by one or more software applications in a verification stage, according to preferred embodiments;

FIGS. 10a-10e show screen shots of a GUI presented by a smartphone in different stages of the verification stage;

FIG. 11 is a flow diagram, similar to the FIG. 9 diagram, indicating processing steps performed by one or more software applications in a verification stage, according to a further embodiment;

FIG. 12 shows a typical paper document with a QR code printed on it and the holographic NFC tag attached to the lower part illustrating how the seal works;

FIG. 13 is an image showing the signature application landing page;

FIG. 14 is an image showing the signature application login page;

FIG. 15 is an image showing the signature application, choosing the signing option;

FIG. 16 is an image showing the signature application's tag scanning operation page;

FIG. 17 is an image showing the signature application's barcode scanning operation;

FIG. 18 is an image showing the signature application's certificate digital signature operation in completion;

FIG. 19 is an image showing the verification application landing page;

FIG. 20 is an image showing the verification application login page;

FIG. 21 is an image showing the verification application's tag scanning operation;

FIG. 22 is an image showing the verification application's scanning operation in progress;

FIG. 23 is an image showing the verification application's tag scanning operation (loading document details);

FIG. 24 is an image showing the verification application's successful page;

FIG. 25 is an image showing the verification application sending the digitally signed copy;

FIG. 26 is an image showing the verification application selecting an option to scan QR code/Bar code so as to send a digitally signed certificate to a recipient;

FIG. 27 is an image showing the verification application sending the digitally signed copy by scanning barcode/QR code;

FIG. 28 is an image showing the verification application to supply the email of the recipient where digital copy of the certificate is to be sent;

FIG. 29 is an image showing the verification application verification history;

FIG. 30 is an image showing the verification application top-up screen;

FIG. 31 is an image showing the verification application credit top-up screen;

FIG. 32 is an image showing the verification application menu option;

FIG. 33 is an image showing the verification application invalid document authentication screen;

FIG. 34 is an image showing the signature application flowchart showing the process for signing a document;

FIG. 35 is an image showing the verification application flowchart showing the process for validating the authenticity of a document, which has been earlier calibrated, using the verification application;

FIG. 36 is an image showing the system activity diagram;

FIG. 37 is an image showing the automated desktop signing application login screen;

FIG. 38 is an image showing the automated desktop signing application dashboard;

FIG. 39 is an image showing a sample digitally signed certificate;

FIG. 40 shows the sample applied on a medical product;

FIG. 41 is an image of the process of verifying the authenticity of the medical item; and

FIG. 42 is an image of the verification application availing a successful scanned Dispirin™ medical drug (as an example) to the user.

### DETAILED DESCRIPTION OF PREFERRED EMBODIMENTS

Embodiments herein relate to methods and systems for verifying the authenticity of paper documents. In this context, a paper document is also intended to encompass, in general, planar paper-like documents (e.g. made of cardboard) which usually have information printed on them. Examples include certificates, bank notes, bank cheques and so on.

In overview, the methods and systems utilise Near Field Communications (NFC) technology. NFC is a set of communications protocols which enable two electronic devices to establish data communications, by bringing them close to one another, typically within about 40 mm or less. NFC protocols are related to radio-frequency ID (RFID) standards. In typical NFC systems, one device is a reader and the other is a card or tag. The card or tag may be passive, i.e. it may have no power source of its own, but receives power through magnetic induction from the reader. NFC standards operate at approximately 13.5 MHz.

A NFC reader may be a dedicated device, or as is becoming common, may be incorporated within a mobile smartphone. It is for example now possible to make contactless NFC payments through smartphones. One or more dedicated NFC applications or ‘Apps’ may be provided and/or downloaded to such devices to manage the NFC hardware, protocols and provide appropriate security measures.

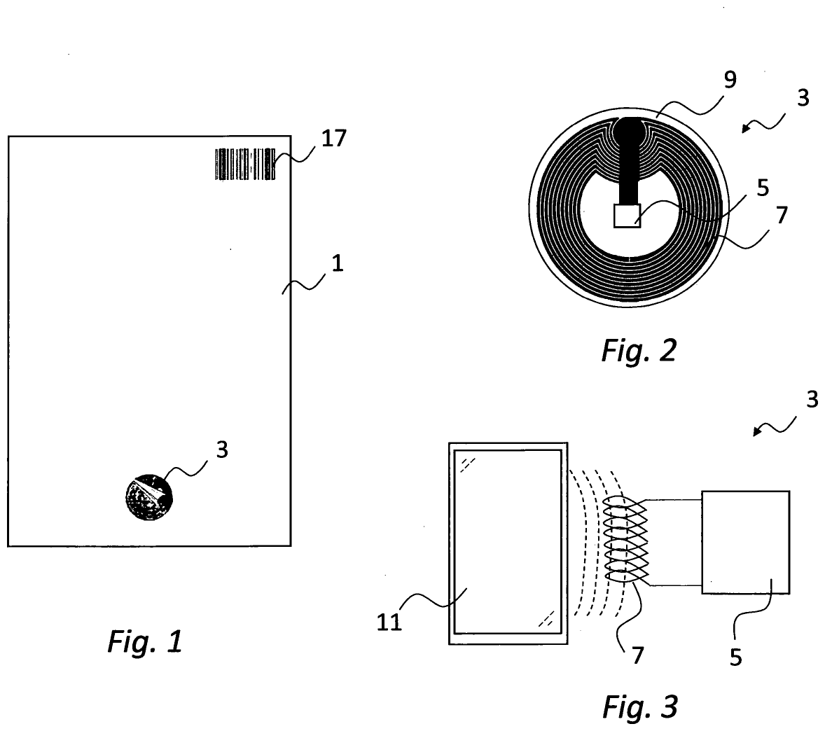

Referring to FIG. 1, a paper document 1 is shown; it is assumed that the document carries some important information, e.g. it is an educational certificate or similar.

Fixed to one side of the document 1 is a NFC tag 3, provided in the form of a label. For example, the NFC tag 3 may be a so called Trusted Tag® provided by HID Global Corporation.

FIG. 2 shows the NFC tag 3 from the rear side. As will be understood, the NFC tag 3 comprises a NFC chip 5 which provides the necessary data and processing circuitry for operation. An antenna coil or loop 7 surrounds the chip 5 in a spiral pattern and is used for receiving RF energy from a reader used to enable and power the chip through magnetic induction. The antenna coil 7 is also used to transmit data back to the reader responsive to the chip 5 being energised. The remaining part of the label, generally indicated 9, is a self-adhesive surface.

The NFC tag 3 is affixed to the document 1 using its self-adhesive underside so that the tag's chip 5 and antenna 7 are concealed from view and cannot be easily accessed. This fixing is typically performed by the document's issuer, e.g. an examination board or educational establishment. Subsequent attempted removal of the NFC tag 3 will cause visible damage to the document 1 and/or the tag.

FIG. 3 is a schematic view of the NFC tag 3 described above and shown in relation to a reader device, which in this case is a NFC enabled smartphone 11 with associated reader circuitry and software/firmware. In other embodiments, other forms of NFC reader device can be employed. In use, when the smartphone 11 is brought close to the NFC tag 3 (with the phone's NFC capability enabled) it will energise the said tag causing it to transmit information back to the phone. The term ‘scanned’ is typically used to denote when the NFC tag 3 is being energised.

In overview, the NFC tag 3 is configured, when scanned by the smartphone 11, to generate an identifier which changes each time the said tag is subsequently scanned. This identifier may be termed a Transaction Authorisation Code (TAC) or One Time Password (OTP).

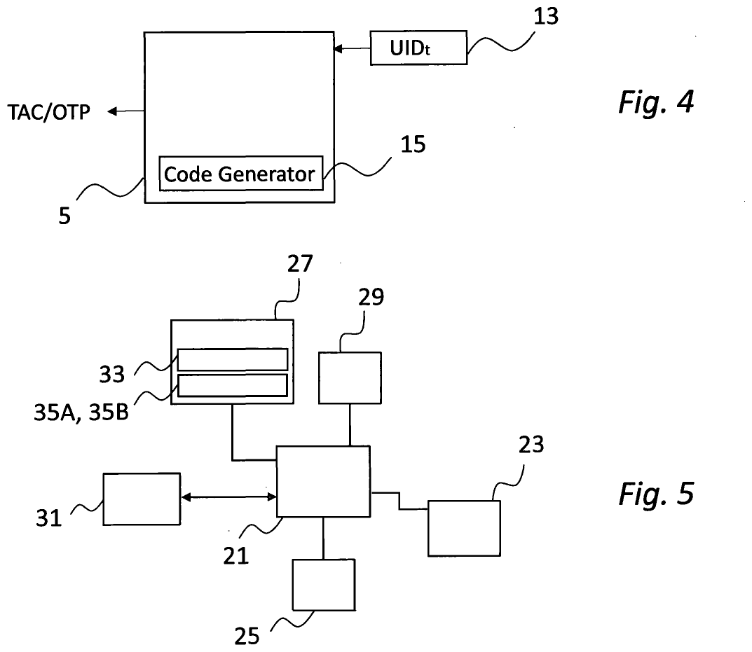

Referring to FIG. 4, the tag chip 5 receives as input a constant value UIDₜ 13 which is a pre-assigned unique data string stored in memory. A code generator function 15 is also provided, typically an embedded algorithm for generating TAC/OTP using the constant value UIDₜ 13. The algorithm 15 may also make use of an incrementing register (as one other input) which changes its value after each scan so that the resulting TAC/OTP changes. The same algorithm and register setup is employed at a remote authentication server so that the TAC/OTP can be verified. The two systems therefore employ a form of ‘shared secret’. This makes it virtually impossible for a hacker or forger to achieve authentication of a copied document merely by accessing and copying the UIDₜ 13. Other related forms of encryption or encoding can be used, where the output from the tag chip 5 will change after each scan.

The TAC/OTP that is generated by the tag chip 5 may be in the form of a URL or in text format. The URL will comprise the TAC/OTP from which can be derived, at the authentication server end, the UIDₜ for comparison and therefore authentication purposes.

Referring back to FIG. 1, a separate form of identifier, referred to as the document identifier or “UID_{d”} is provided on the document 1 in the form of a barcode 17. As will be appreciated, the barcode 17 can be used to represent a data string which is decoded using a suitable image scanning application. In some embodiments, other forms of visual marking can be used for the UID_{d}, such as a QR code, a string of alphanumeric characters or the like, to give some examples.

The barcode 17 is directly printed on the document 1 at a location spatially separate and distinct from the NFC tag 3. The UID_{d} is a constant value assigned by the issuing authority.

Thus, the document 1 comprises two different identifiers: UIDₜ and UID_{d}. The first is transmitted in an encoded form (TAC/OTP) as a URL or in text format when the NFC tag 3 is energised, and then changes for subsequent scanning operations. The second is printed on the document 1 in visual form and does not change.

FIG. 5 shows an example schematic diagram of components of the smartphone 11. The smartphone 11 has a controller 21, a display 23, which may be a touch sensitive display, hardware keys 25, a memory 27, RAM 29, and a NFC interface 31 comprising the hardware, firmware and antenna circuitry appropriate for the NFC protocol. The controller 21 is connected to each of the other components in order to control operation thereof.

The memory 27 may be a non-volatile memory such as read only memory (ROM) a hard disk drive (HDD) or a solid state drive (SSD). The memory 27 stores, amongst other things, an operating system 33 and one or more software applications 35. The RAM 29 is used by the controller 21 for the temporary storage of data. The operating system 33 may contain code which, when executed by the controller 21 in conjunction with RAM 29, controls operation of each of hardware components of the terminal.

The controller 21 may take any suitable form. For instance, it may be a microcontroller, plural microcontrollers, a processor, or plural processors.

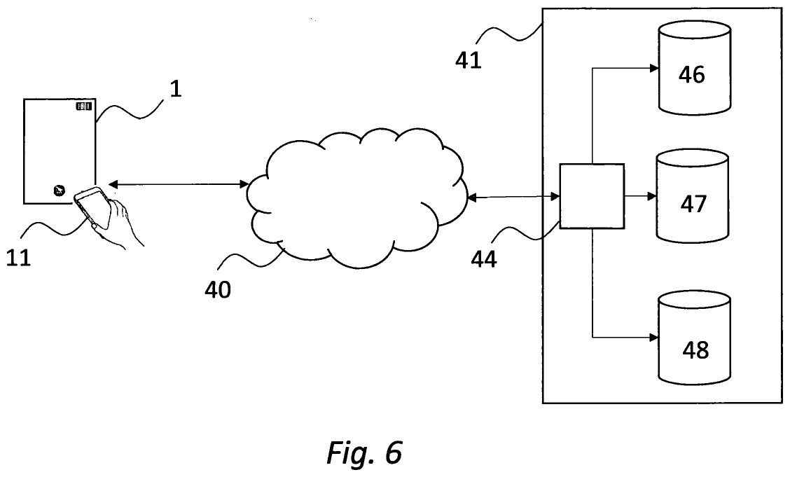

Referring to FIG. 6, the document 1 and smartphone 11 are shown in relation to a remote, trusted authentication authority 41. The two ends are connected by a network 40, e.g. the Internet and so the authority can be considered a ‘cloud’ type system. The authentication authority 41 operates a secure webserver 44 which has access to various databases 46, 47, 48. For example, a first database 46 stores a list of issuers and their details. For example, a second database 47 stores a list of verifiers and their details. For example, a third database 48 stores a list of signed document details.

The software application 35 may be configured to provide either or both of a calibration application and/or a verification application. For convenience, we indicate two such software applications 35A, 35B. Specifically, a first software application 35A is a calibration application and a second software application 35B is a verification application. The two software applications 35A, 35B may be provided on the same or on different smartphones. In some embodiments, the two software applications 35A, 35B may be combined in a single application with different modes.

Calibration is the stage whereby the issuer of the document 1, e.g. an examination board, registers the document with the trusted authentication authority 41. It may also be referred to as ‘signing’ the document 1. Verification is the stage whereby a different party, e.g. an employer wishing to authenticate a presented document, communicates with the authentication authority 41 for a response.

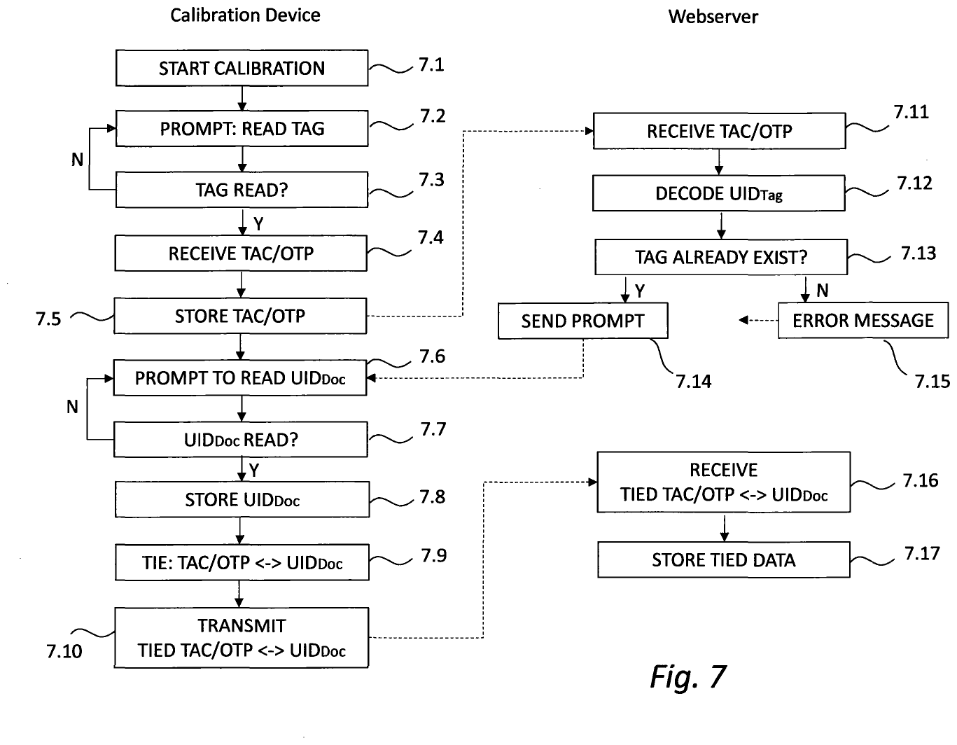

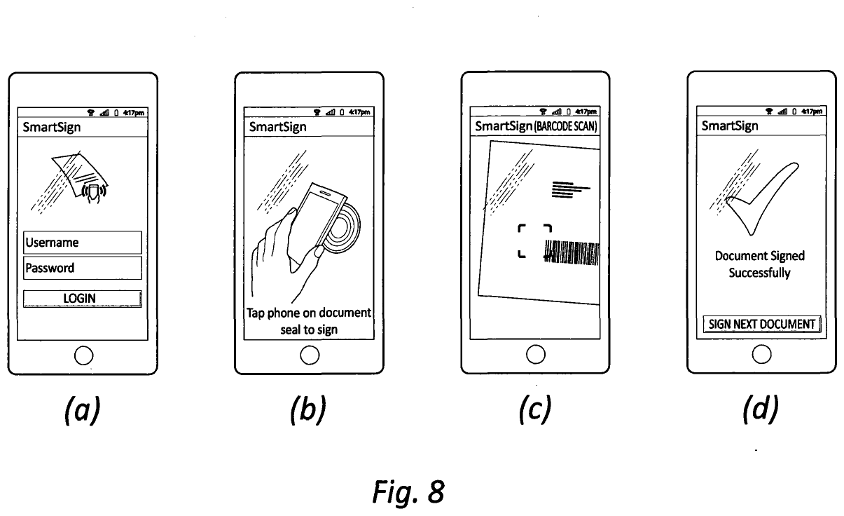

The calibration process will now be explained with reference to FIGS. 7 and 8.

FIG. 7 is a flow chart showing the various process stages performed by the calibration application 35A when run on the smartphone 11. FIG. 7 also shows related process stages performed at the authentication server 44. The numbering used on FIG. 7 is not necessarily indicative of the order of the steps. It will also be appreciated that some steps can be interchanged or avoided.

Initially, in step 7.1 the issuer of the document 1 will open the calibration application 35A on the smartphone 11. The application 35A contains an embedded link for communicating over a TCP/IP network with the authentication server 44, using an encrypted protocol such as SSL.

If not done already, the issuer will be prompted by the calibration application 35A to register their organisation's details with the authentication server 44 via a secure portal, e.g. by entering a user id, a password and additional contact and address details. This information is then stored on the first database 46. If already registered, the issuer simply enters their user id and password on the login screen, as shown in FIG. 8a.

In step 7.2 the issuer is prompted to read or scan the NFC tag 3 as shown in FIG. 8b. In step 7.3 it is determined if the NFC tag 3 has been read; if not, the process returns to step 7.2. If the NFC tag 3 is read, in step 7.4 the TAC/OTP is received as a URL or in text format and in step 7.5 is stored in memory of the smartphone 11. The URL may include a pointer to the authentication server 44 as well as the TAC/OTP.

Responsive to reading and storing the TAC/OTP, in step 7.6 the issuer is prompted automatically to read the UID_{d}. In this example, this is by means of the application 35A opening an image capture application (associated with the smartphone's in-built camera) configured to detect and decode barcodes to obtain the UID_{d}. As indicated in FIG. 8c, the issuer scans over the barcode 11 (by aligning the camera over it using the screen) until confirmation is received that the barcode is detected and read in step 7.7.

The UID_{d} is stored in step 7.8. In step 7.9 the issuer is prompted to tie or link the UIDₜ and UID_{d} together. This pairing of the two identifiers is then transmitted in step 7.10 to the authentication server 44 where they are stored in the third database 48.

Referring to steps performed by the authentication server 44, in optional stages 7.11 to 7.15 the server may first determine whether or not the UIDₜ has already been stored in the third database 48, which if so, would indicate an unauthorised calibration attempt which is denied. If the UIDₜ has not already been received and stored, then a message is sent back to the smartphone 11 prompting the next stage 7.6 of calibration.

Steps 7.16 and 7.17 indicate the receiving and storing stages of the paired UIDₜ and UID_{d} at the authentication server 44. UIDₜ is decoded from the TAC/OTP using the ‘shared secret’ method mentioned above.

FIG. 8d shows the user interface output indicating successful signing of the document 1 to the issuer.

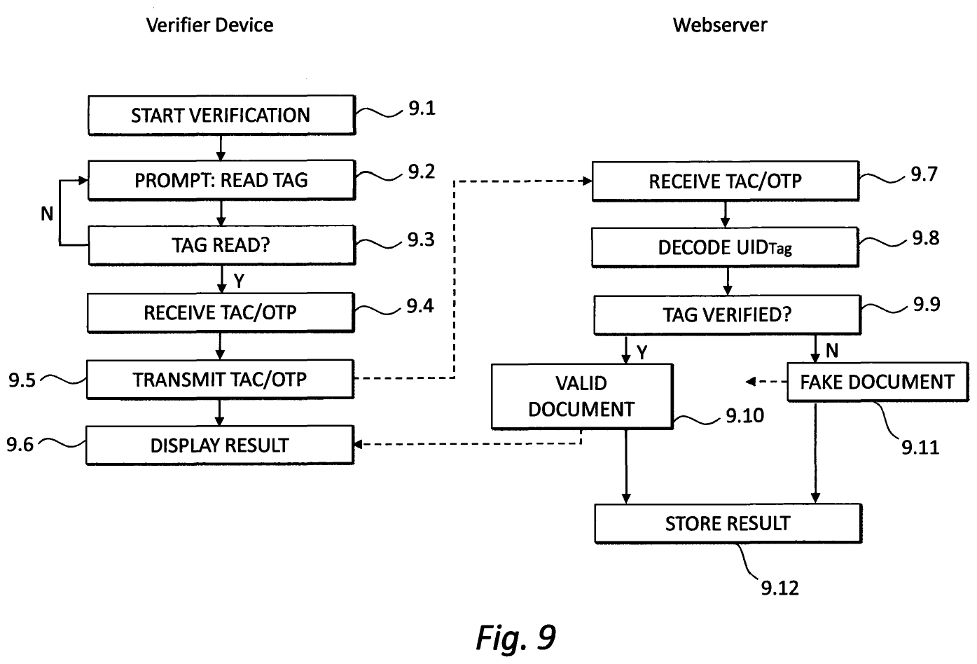

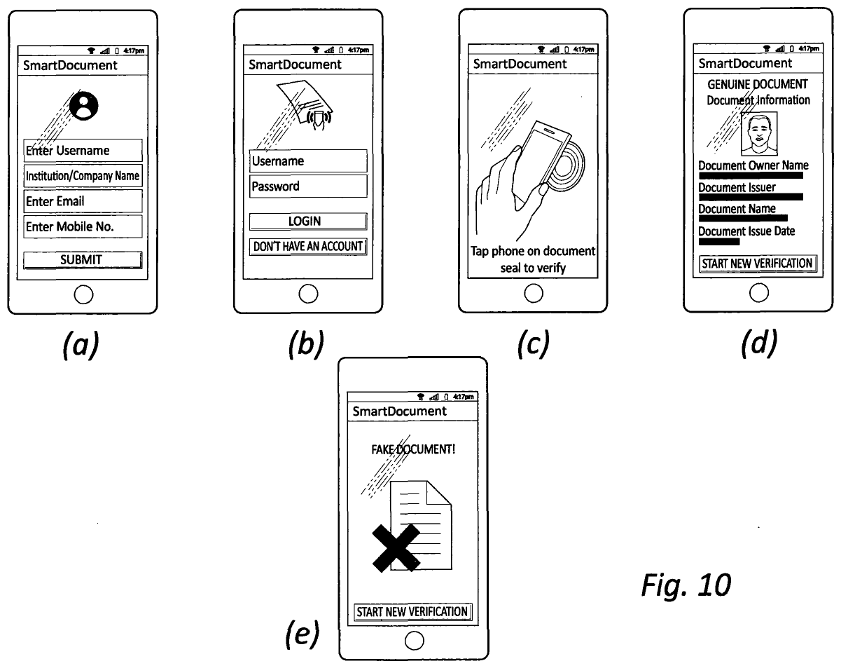

The verification process will now be explained with reference to FIGS. 9 and 10.

FIG. 9 is a flow chart showing the various process stages performed by the verification application 35B when run on the smartphone 11, or a different NFC enabled device. FIG. 9 also shows related process stages performed at the authentication server 44. The numbering used on FIG. 9 is not necessarily indicative of the order of the steps. It will also be appreciated that some steps can be interchanged or avoided.

Initially, in step 9.1 the verifier of the document 1 will open the calibration application 35B on the smartphone 11. The application 35B contains an embedded link for communicating over a TCP/IP network with the authentication server 44, using an encrypted protocol such as SSL.

If not done already, as shown in FIG. 10a, the verifier will be prompted by the calibration application 35B to register their individual or organisation's details with the authentication server 44 via a secure portal, e.g. by entering a user id, a password and additional contact and address details. This information is then stored on the second database 47. If already registered, the verifier simply enters their user id and password on the login screen, as shown in FIG. 10b.

In step 9.2 the verifier is prompted to read or scan the NFC tag 3 as shown in FIG. 10c. In step 9.3 it is determined if the NFC tag 3 has been read; if not, the process returns to step 9.2. If the NFC tag 3 is read, in step 9.4 the TAC/OTP is received as a URL or in text format and in step 9.5 is stored in memory of the smartphone 11 and transmitted to the verification server 44.

At the verification server 44 the TAC/OTP is received and decoded in step 9.8 to provide the UIDₜ using the above-mentioned shared secret method. In step 9.9 the UIDₜ is compared with those stored in previous calibration steps, i.e. those stored in the third database 48, to determine whether there is a match, in which case the document 1 is authentic (step 9.10). If there is no correspondence, it is determined that the document 1 is fake (step 9.11). The result may be stored in step 9.12 and, in either case, is transmitted back to the verifier's smartphone 11 for displaying the result in step 9.6.

FIG. 10d shows a user interface following authentication. FIG. 10e shows a user interface following failed authentication.

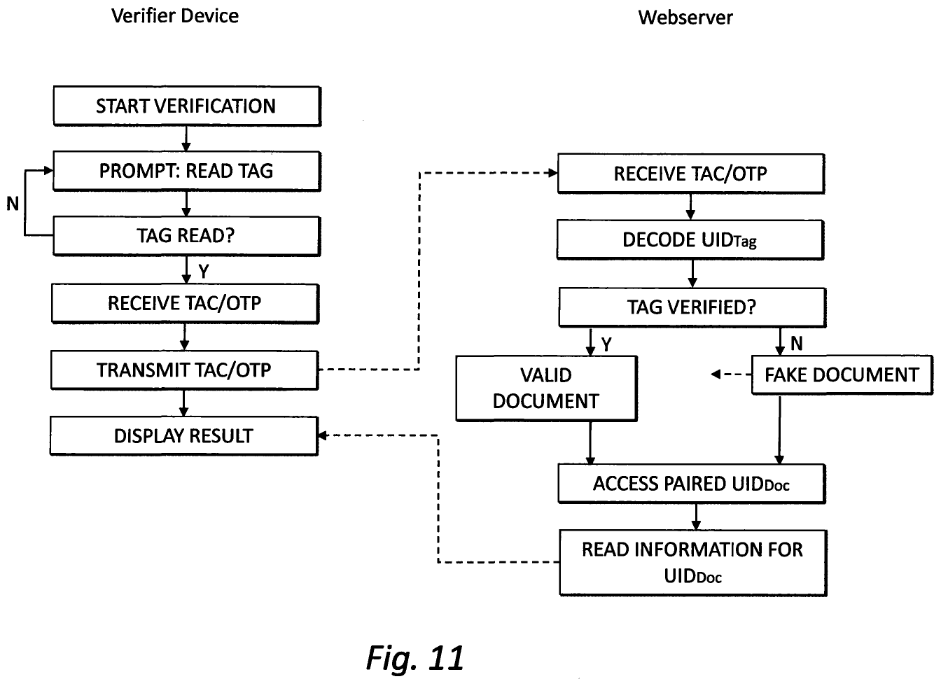

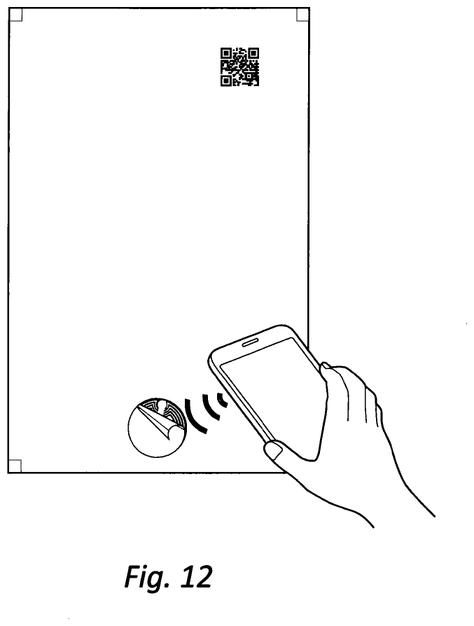

In some embodiments, which is particularly applicable if the document is an educational certificate or the like, in response to an authentication result (step 9.10) additional information based on, or associated with, the UID_{d} may be presented on the user interface, for example as shown in FIG. 10d. In this regard, the UID_{d} may point to the name of the document owner, the issuing organisation, the document name and/or the issue or creating date. FIG. 11 shows in overview such a method.

The above described methods and systems help overcome or minimise the problems associated with document forgery, and one which can be applied in a localised or global manner given the nature of the Internet.

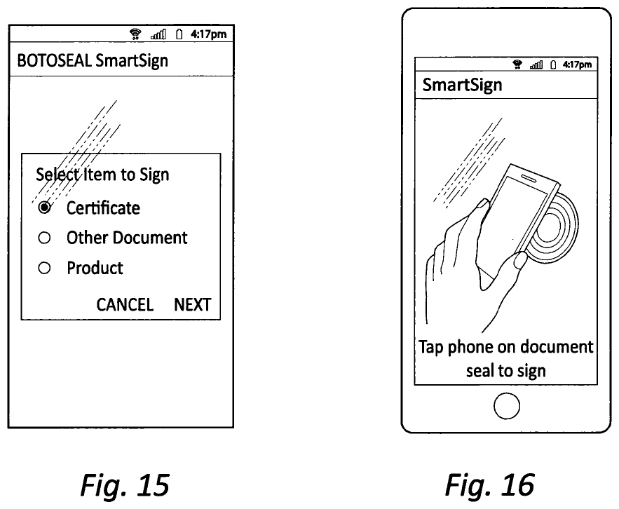

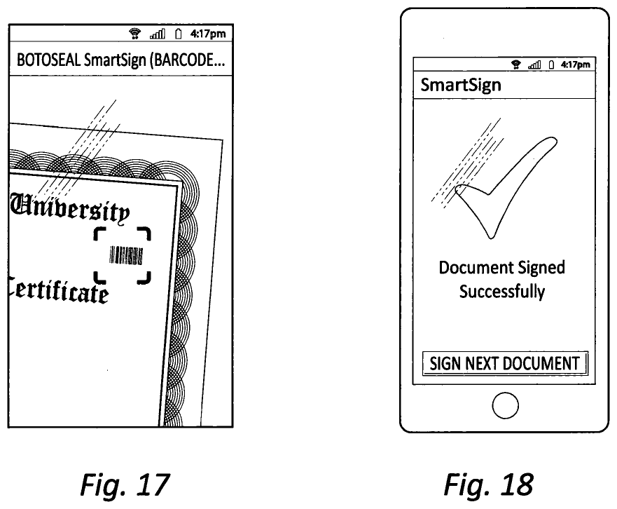

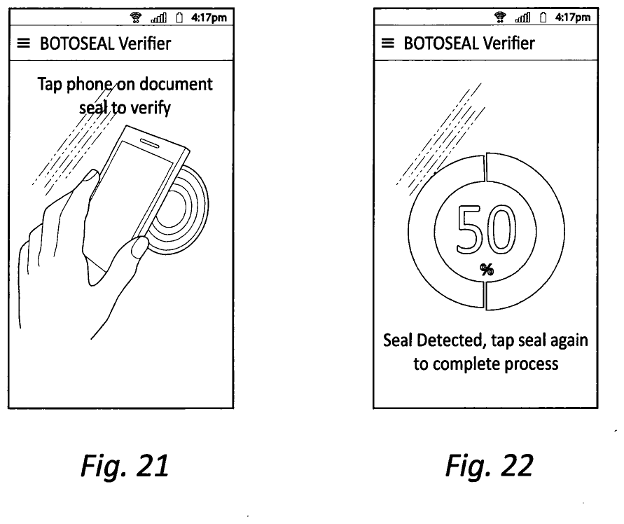

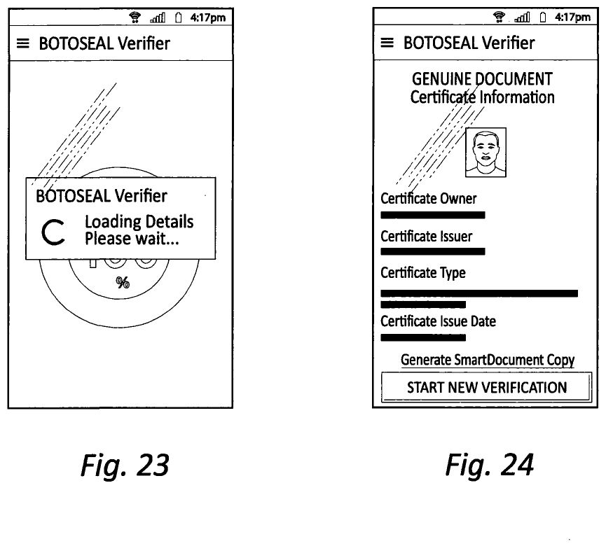

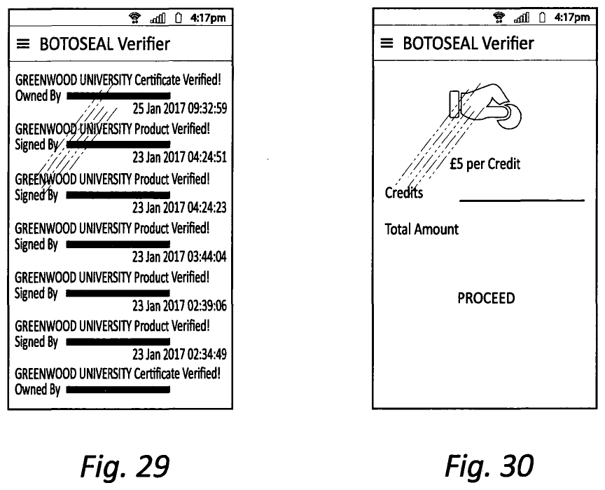

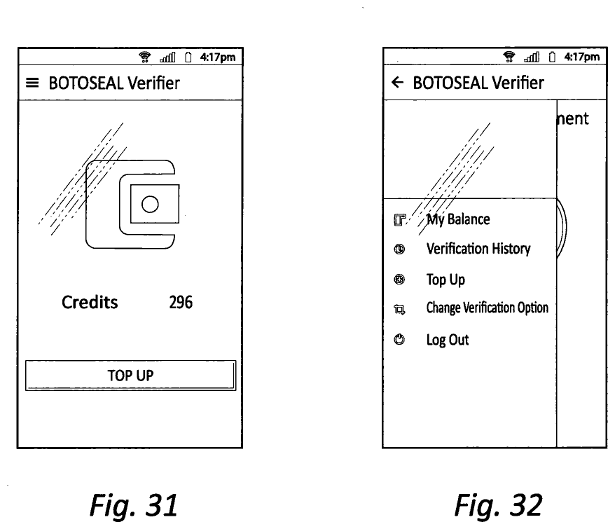

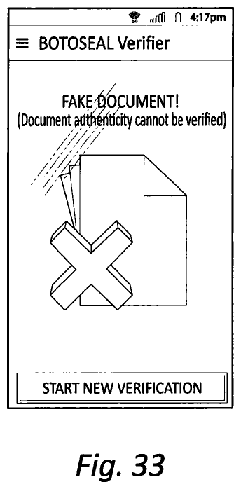

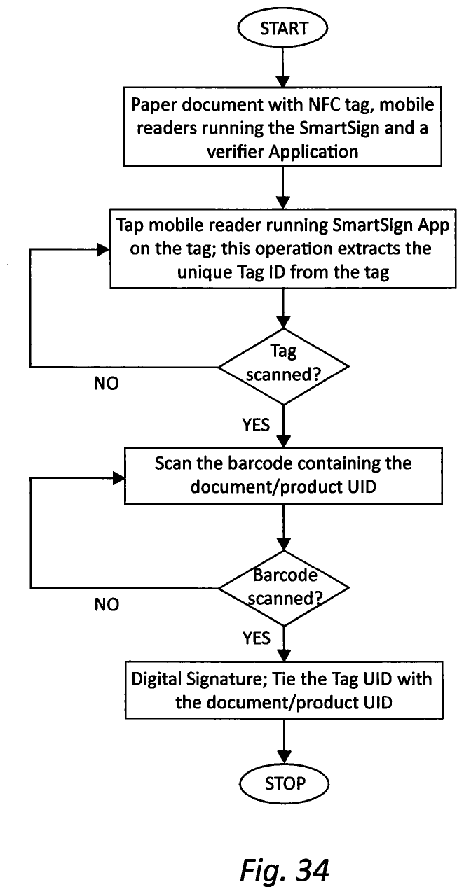

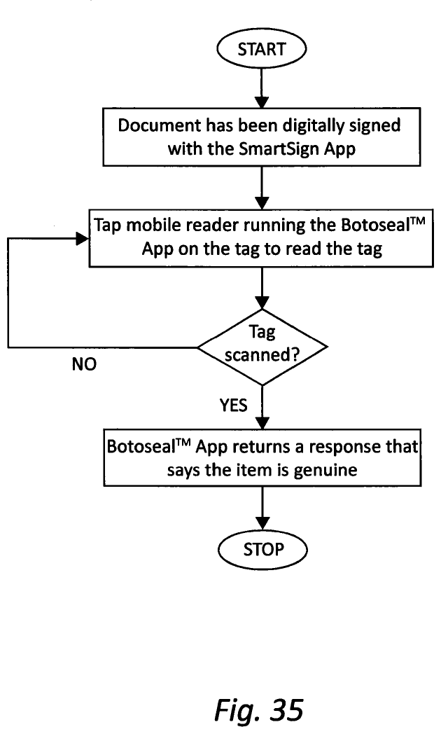

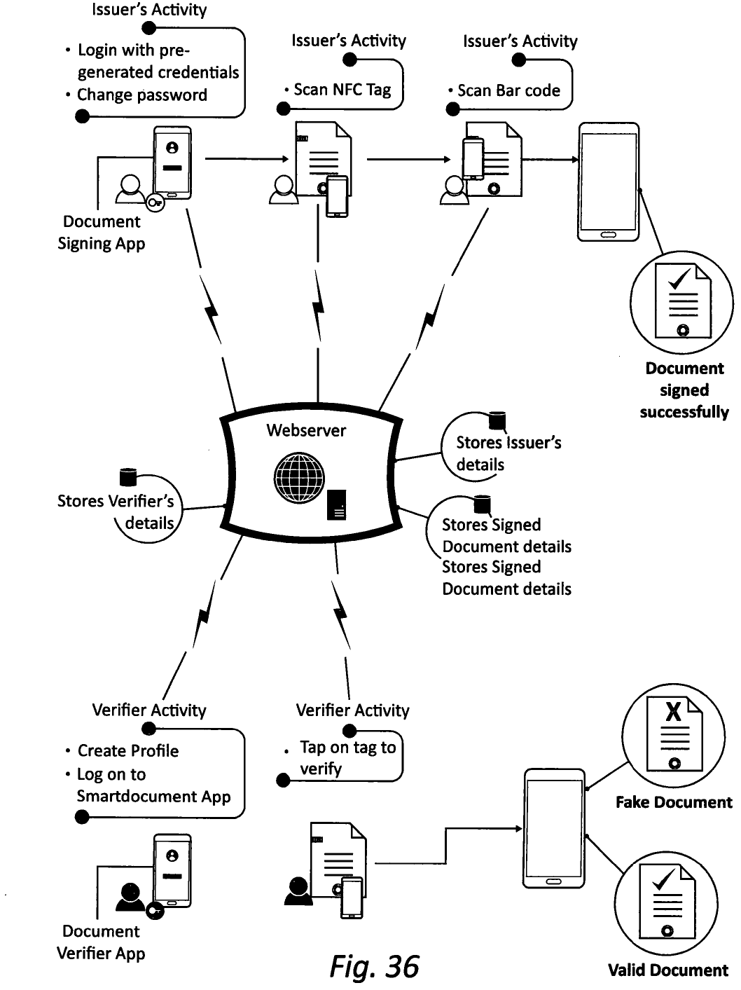

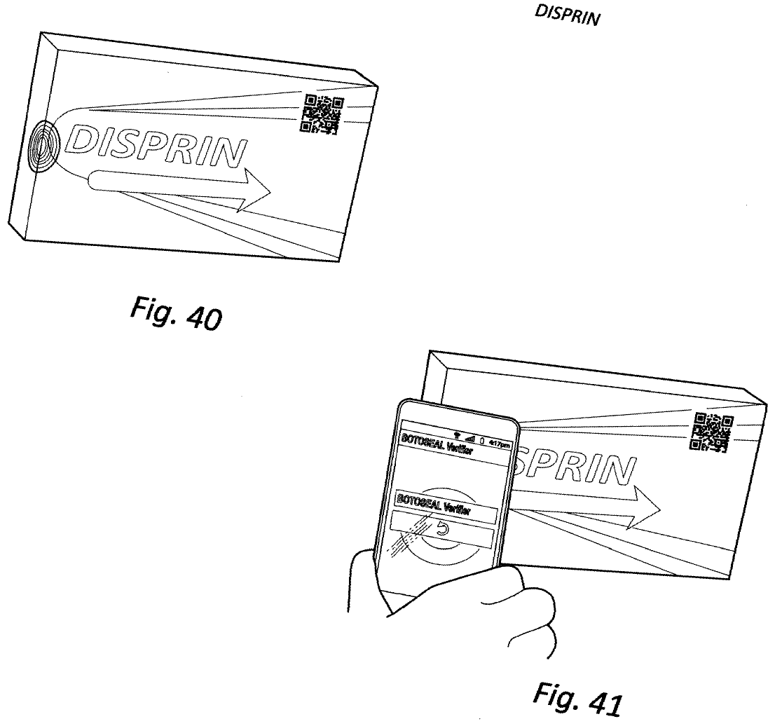

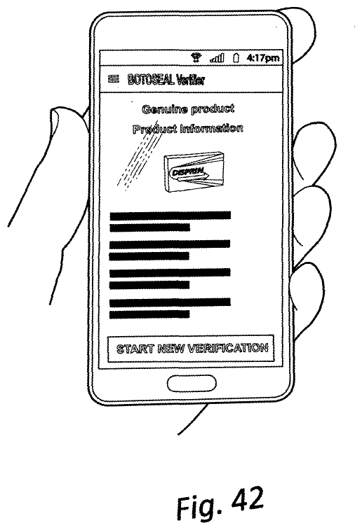

FIGS. 12 to 42 illustrate another embodiment or additional parts to the previous described embodiment of a system for validating the authenticity of a document and/or products through the use of Near Field Technology. The system comprises a holographic NFC tag (Trusted Tag®), a bespoke signature application, a bespoke verification application, an NFC enabled mobile device that runs the signature application and an NFC enabled mobile device that runs the verification application.

A Paper Document with an NFC Tag

An NFC tag is attached to a document (for example, a certificate, a letter etc) via a simple adhesion technique.

Issued documents are coded with a Barcode/QR Code printed on document. The Barcode/QR Code is encoded with the encrypted unique identification number (UID) of the document which, in the example shown in FIG. 12, is a student examination number. Other documents (such as letterheads, medical reports etc.) may only have NFC tags attached. The NFC tag used is a secure tag which, when tapped with an NFC enabled device, generates a Transaction Authorization Code (“TAC”) or a One-Time Password (“OTP”) as a URL which provides access to validate the authenticity of the document. The TAC or OTP is a security measure which ensures that the tag cannot be cloned as the device generates a different TAC/OTP every time the tag is tapped on the device.

Each tag has a unique Identification number (UID) which has been encoded within the tag. The Tag UID is the only constant variable the tag generates every instance it is tapped. Consequently, upon scanning of a tag, a different information (TAC/OTP) is generated every time but the Tag UID is constantly generated. This allows each physical tag to be identifiable by their corresponding UIDs.

The Signature Application

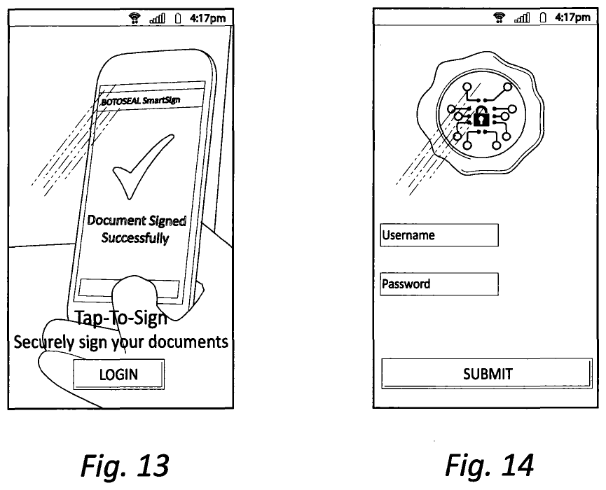

The signature application is shown in FIGS. 13 to 18. The application is developed to sign documents for future verification.

For document security, certification signing involves the tying of the unique document ID with the Tag ID. A unique designation is formed which is then stored on a cloud based database containing information data on that document.

The signing of documents may alternatively or additionally involve the tying of the document issuer details/ID with the Tag ID.

Product signing involves the tying of the product details (manufactured date, batch no. etc.) with the Tag ID.

The process of signing the issued documents and product is initiated with having an NFC enabled mobile device which has the associated the signature application running on it. The document issuer securely logs in to the application on their mobile device with username and password, and selects from the options which type of document they wish to sign. The mobile device is then used to tap the Tag which generates a TAC/OTP inform of a URL that contains the unique ID (UID) of that tag. The UID of the Tag is automatically copied by the application.

As this process is completed, for certificates for example, the application automatically prompts open the device camera so as to capture and read the Barcode/QR code. The information on the Barcode/QR code which is the UID of the document is copied by the application and automatically tied to the Tag ID previously copied. For other documents/products, the tag ID copied may be automatically tied to the document/product issuer's profile (gathered from information that was provided upon signing-up to system and which will be subsequently provided when such document is verified). These signing processes are repeated for all documents. This process is shown by way of example in FIGS. 13-18.

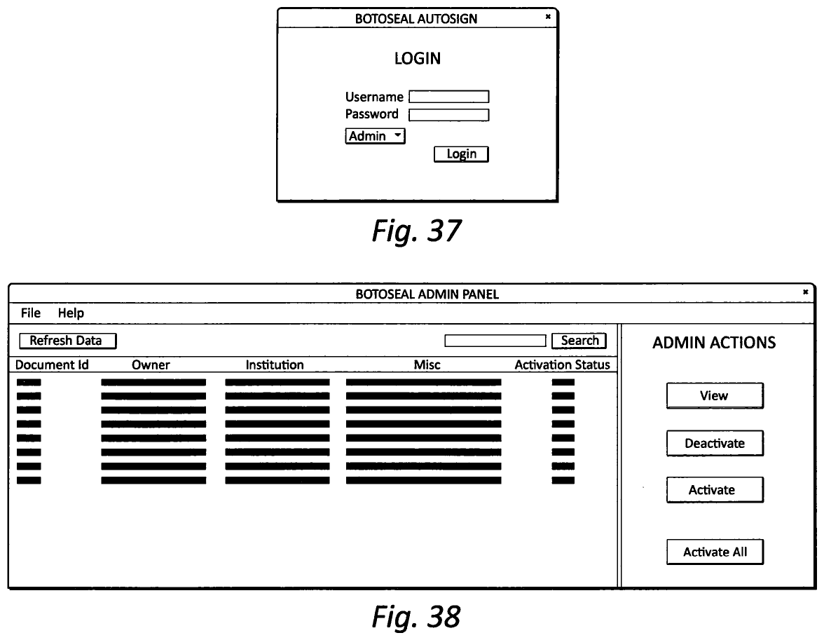

Document signing can also be done in batches with the automated signature application as shown by way of example in FIGS. 37 and 38.

The Verification Application

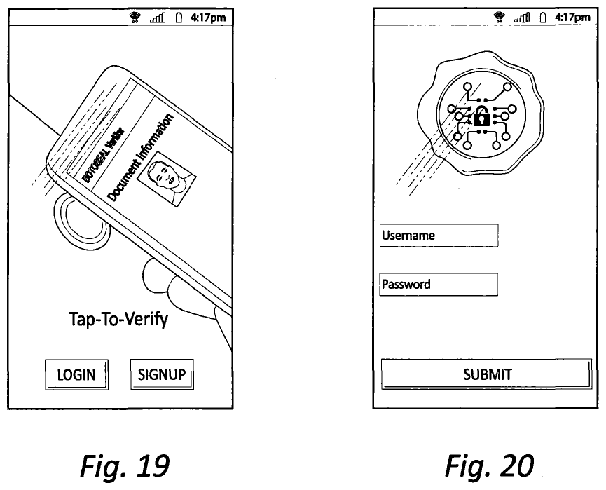

The verification application is shown by way of example in FIGS. 19 to 24. This application is developed to read the tag and carry out the verification of paper document authenticity.

An NFC enabled mobile device is tapped on the tag and the verification application is launched (if previously installed) or downloaded to start verification. The document verifier securely logs in and selects an option to either scan Barcode/QR code (to generate digital copy of certificates) or scan NFC tag (document verification). The verifier is prompted to tap twice on the tag to generate a unique TAC/OTP that is authenticated before the document's specific information is retrieved from the cloud service, the verification application returns a message that states that the document being verified is genuine and authentic, or fake.

The Web Server

The tag UIDs and document/product UIDs for all items that are tied using the signature application are stored on a database which is housed on a web server. This system ensures that whenever any tag is scanned and a TAC or an OTP is generated, the URL communicates with the web server to confirm if the tag exists or not. If the tag exists, the tag ID would be present on the database which will return a positive report that the document is genuine since the tag has been tied to a specific information on the database. Therefore, every tag issued can be uniquely identified, hence stopping the problems of duplicating or fabricating a document.

In another embodiment of the invention, the document/product being verified may be a certificate from an educational institution, a product from a manufacturing company, etc.

The report which is returned by the application may either be a valid response to confirm to the verifier that the issued document/item is genuine, or an invalid response that confirms to the verifier that the issued document or supplied product is not genuine. In this embodiment, a database which contains the UIDs for all the documents is built with the document in this case, being a certificate. In such a case the UID for the document may be a number that uniquely differentiates it. This may be the examination number of candidate or the matriculation number of such candidate for example.

For products, the UID of the product could be the serial number of the product or the IMEI number of such product i.e. a number that uniquely identifies the product to its brand.

After a successful check for the authenticity of the tag by the system, the database is securely queried to retrieve document specific data which is then displayed to the verifier on the verification application. The information displayed may be the candidate name, age, date of birth, date the document was issued, grades and other specific information as required by the issuer in case of issued document.

This information may alternatively be the name of the product, the manufacturer's information, the NAFDAC number of the product, the manufactured date, the expiry date, and the warrantee status of the product/item to be validated.

Sending a Digital Copy

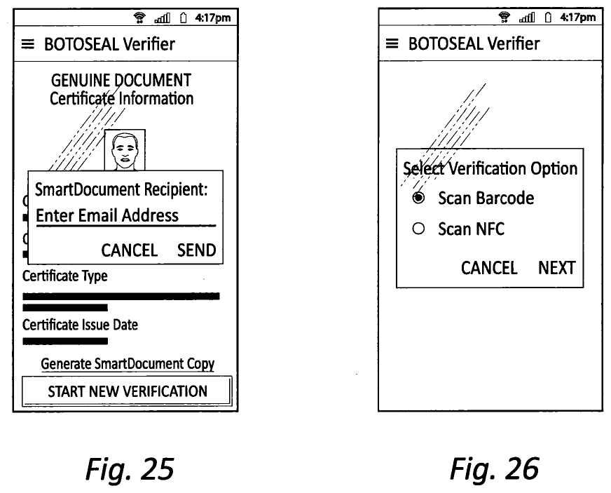

A digital copy of a signed certificate can be sent from the verification application as shown by way of example in FIGS. 24 and 25. This is to enable document verifier to send an adobe digitally signed copy of the verified certificate to an authorized recipient.

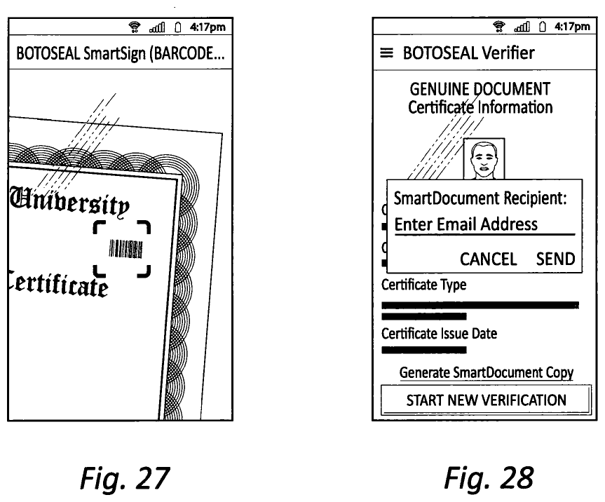

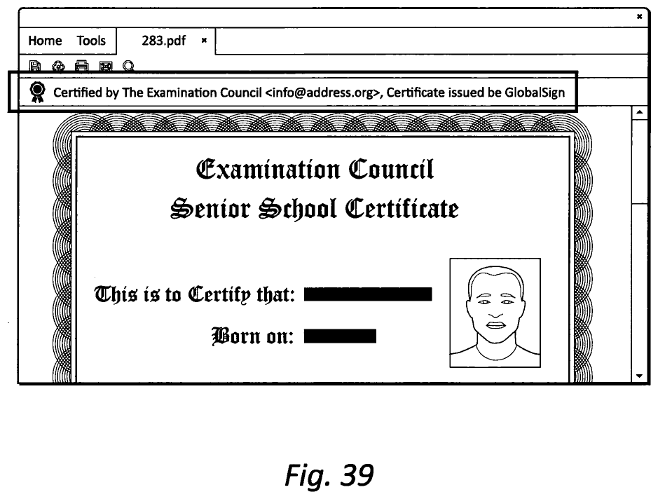

A sample of a digitally signed document is as shown by way of example in FIG. 39. A digital copy of an issued document can also be generated and sent to an authorized recipient by just scanning the unique barcode/QR code of the issued document as shown by way of example in FIG. 27.

It will be appreciated that the above described embodiments are purely illustrative and are not limiting on the scope of the invention. Other variations and modifications will be apparent to persons skilled in the art upon reading the present application.

1. A method comprising:
receiving from a contactless radio frequency tag document identification data and tag identification data stored on the contactless radio frequency tag on a document;
receiving the document identification data provided on and associated with the document; and
transmitting data representing the tag identification data and the document identification data as a linked pair to a remote device.

2. The method of claim 1, wherein the document identification data is fixed on the document, at a spatially separate location from the contactless radio frequency tag.

3. The method of claim 1, wherein the document identification data is provided in visible text or a graphic marking.

4. The method of claim 3, wherein the document identification data is provided in a barcode or a quick response (QR) code.

5. The method of claim 1, wherein the document identification data is received from an image data which represents a captured part of the document.

6. The method of claim 5, wherein the image data is received from an image capture application opened responsive to receiving the tag identification data.

7. The method of claim 1, performed using a mobile communications device having contactless radio frequency ID (RFID) or Near Field Communication (NFC) reading capability.

8. A method of authenticating a document, comprising:
storing for at least one document a set of linked validation data that includes a tag identification data associated with a radio frequency tag on the document, and a document identification data provided on and associated with the document;
receiving a verification request from a remote communications device, which a verification request includes the tag identification data;
comparing the received tag identification data in the verification request with each set of stored validation data; and
responsive to identifying a correspondence between the received and stored tag identification data transmitting an authentication message back to the remote communications device.

9. The method of claim 8, wherein the receiving of the verification request further includes identifying a user or device, and determining that the user or device is pre-registered before performing the comparing.

10. The method of claim 8, wherein the receiving of the verification request includes an encoded form of the tag identification data, and further includes decoding the tag identification data before the comparing.

11. The method of claim 10, wherein the encoded form of the tag identification data is decoded using a shared secret with the radio frequency tag.

12. The method of claim 11, wherein the decoded tag identification data changes for each subsequent decoding operation.

13. The method of claim 8, wherein the receiving of the verification request is received as a URL.

14. The method of claim 8, wherein the identifying includes providing to the remote communications device the document identification data, or other data associated the document identification data, which corresponds to the verified tag identification data.

15-31. (canceled)

32. A secure document verification system comprising:
a document tagged with an NFC Tag which generates unique information each time it is scanned;
a signature application which calibrates the document for future verification through digital signing of the document;
a verification application which carries out a verification process for the document; and
a web server which serves as a repository for the unique information for all signed documents and which can be queried by the verification application during the verification process to return a valid or invalid message to a user of the application depending on the response of the verification process.

33. The system of claim 32, wherein the document comprises a bank note, bank cheque, educational certificate, diploma, stock certificate, or a document that is commonly forged.

34. The system of claim 32, wherein the NFC tag comprises a NFC chip which provides the necessary data and processing circuitry for operation.

35. The system of claim 34, wherein the NFC chip comprises an antenna coil for receiving RF energy from a reader used to enable and power the chip through magnetic induction.

36. The system of claim 32, wherein the verification application runs on a NFC enabled mobile device.

37. The system of claim 36, wherein the NFC enabled mobile device is associated with reader circuitry and software.
